(19) United States
(12) Patent Application Publication
(10) Pub. No.: US 2001/0018205 A1
(43) Pub. Date: Aug. 30, 2001

(54) Process for stereospecific hydrolysis of piperidinedione derivatives

(75) Inventors: Alan David Curzons, Arundel (GB); Lawson Willian Powell, Worthing (GB); Alan Martin Keay, Rustington (GB)

Correspondence Address: SMITHKLINE BEECHAM CORPORATION, CORPORATE INTELLECTUAL PROPERTY-US, UW2220, P. O. BOX 1539, KING OF PRUSSIA, PA, 19406-0939, US

(73) Assignee: SmithKline Beecham plc

(21) Appl. No.: 09/813,755

(22) Filed: Mar. 21, 2001

Related U.S. Application Data
(63) Continuation of application No. 09/467,811, filed on Dec. 20, 1999, now abandoned.
Application No. 09/467,811 is a continuation of application No. 09/119,786, filed on Jul. 21, 1998, now abandoned.
Application No. 09/119,786 is a continuation of application No. 08/946,526, filed on Oct. 7, 1997, now abandoned.
Application No. 08/946,526 is a continuation of application No. 08/331,597, filed on Nov. 4, 1994, now abandoned.
Application No. 08/331,597 is a continuation of application No. PCT/GB93/00721, filed on Apr. 6, 1993.

(30) Foreign Application Priority Data
May 6, 1992 (GB) 9209687.4

(51) Int. Cl. C12S 13/00

(52) U.S. Cl. 435/280

(57) ABSTRACT

A process for stereospecifically hydrolysing a mixture of the (+) and (−) isomers of a compound of formula (II), in which R is C₁₋₆ alkyl; using a carboxyl esterase enzyme, (I) to form a compound of formula (IIIA), and thereafter separating the resulting compound of formula (IIIA) from the remaining (−) isomer of formula (II); or (ii) to form a compound of formula (IIIB) and thereafter separating the resulting compound of formula (IIIB) from the remaining (+) isomer of formula (II).

The present invention is concerned with a new process and certain novel intermediates.

U.S Pat. No. 4,007,196 describes a class of compounds which possess anti-depressant activity. One specific compound mentioned in the patent is paroxetine which is described as possessing anti-depressant activity.

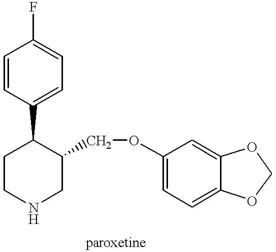

This compound has now been approved for human use in some countries and is being sold as an anti-depressant agent.

All described processes for preparing paroxetine involve chemical reactions such as those described in U.S. Pat. No. 4,902,801. It will be appreciated that paroxetine is actually the (−) isomer (as shown above) and that all chemical methods of preparing paroxetine involve a chemical resolution step which wastes substrate and reactants and necessitates the use of expensive resolving agents and is a fairly expensive reaction to perform.

The present invention involves the use of an enzymatic resolution step which allieviates or overcomes a number of problems associated with a purely chemical resolution step.

Accordingly, the present invention provides a process for stereospecifically hydrolysing a mixture of the (+) and (−) isomers of a compound of formula (II):

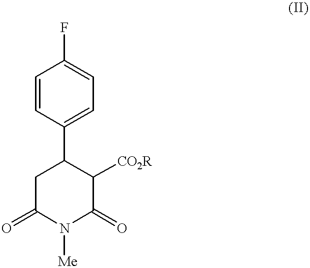

in which R is C₁₋₆ alkyl; using a carboxyl esterase enzyme,

(i) to form a compound of formula (IIIA),

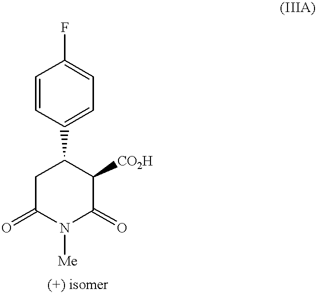

and thereafter separating the resulting compound of formula (IIIA) from the remaining (−) isomer of formula (II); or

ii) to form a compound of formula (IIIB):

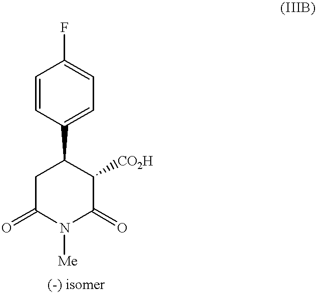

and thereafter separating the resulting compound of formula (IIIB) from the remaining (+) isomer of formula (II).

It should be appreciated that the choice of carboxy esterase enzyme will determine which isomer of formula (II) is hydrolysed to the corresponding acid, which may be determined by routine experimentation.

Process variant i) is preferred.

When using process variant (i) the stereoselectivity of the process is such that from a racemic mixture of a compound of formula (II), after the action of the carboxyl esterase enzyme the ratio of (−) to (+) isomer of formula (II), is greater than 60%, preferably greater than 70%, more preferably greater than 80% and most preferably greater than 85%.

When using process variant (ii) the stereoselectivity of the process is such that from a racemic mixture of a compound of formula (II), after the action of the carboxy esterone enzyme, the ratio of (+) to (−) isomer of a compound of formula (II), is greater than 60%, preferably greater than 70%, more preferably greater than 80% and most preferably greater than 85%.

The process is suitably carried out by dissolving the (±) unresolved compound of formula (II) into a suitable solvent such as an aqueous/organic solvent mixture and adding the carboxyl esterase enzyme and stirring the resulting mixture until the reaction is completed.

Suitable temperatures for performing the reaction include 0-50° C. more suitably 10-40° C. and yet more suitably 25 to 35° C. and most suitably at 30° C.

Suitably aqueous/organic solvent mixtures include buffered aqueous solvents such as tris buffer which is mixed with DMSO.

Suitable pH's for the reaction to be carried out and include pH 4 to 8, more suitably pH 5 to 7 and preferably at pH 5.5.

Suitable values for the variable R include methyl and ethyl. Preferably R is ethyl.

The term carboxyl esterase enzyme is internationally recognised as being those enzymes which fall within the class EC 3.1.1.

Suitable carboxyl esterase enzymes include Porcine liver esterase and Bovine liver esterase both of which are commercially available or may be extracted from Porcine liver or Bovine liver respectively by using procedures available in the literature.

It should also be appreciated that carboxyl esterase enzymes produced by microbes are also suitable for use in the present invention.

In process variant i) where the carboxyl esterase enzyme stereospecifically hydrolyses the (+) form of a compound of formula (II), the remaining (−) form of a compound of formula (II) is separated by conventional techniques such as solvent extraction of the compound of formula (II) using a non-aqueous miscible solvent such as ethyl acetate and the resulting (−) compound of formula (II) may then be isolated using conventional techniques such as precipitation.

The present invention also extends to a process for subsequently converting the (−) compound of formula (II) prepared as described above to paroxetine or a pharmaceutically acceptable salt and/or solvate thereof such as the hydrochloride hemi-hydrate, for example, using the procedures outlined in U.S. Pat. Nos. 4,902,801 and 4,721,723.

In process variant ii) where the carboxyl esterase enzyme stereospecifically hydrolyses the (−) form of a compound of formula (II) to yield the (−) form of a compound of formula (III), the remaining (+) form of a compound of formula (II) may be separated from the (−) form of a compound of formula (III) as mentioned above.

The (−) compound of formula (III) may be converted to paroxetine by first converting it to a (−) compound of formula (II) using conventional esterification techniques. The ester may then be converted to paroxetine or a pharmaceutically acceptable salt and/or solvate thereof such as the hydrochloride hemi-hydrate, for example, using the procedures outlined in U.S. Pat. Nos. 4,902,801 and 4,721,723.

Alternatively, the (−) compound of formula (III) may be directly converted to paroxetine by reducing the carboxylic acid group to a hydroxymethyl group and reducing the two keto groups in the piperidine ring using conventional reducing agents such as lithium aluminium hydride. Subsequently, the resulting piperidine carbinol compound may be converted to paroxetine or a pharmaceutically acceptable salt and/or solvate thereof such as the hydrochloride hemi-hydrate, for example, using the procedures outlined in U.S. Pat. Nos. 4,902,801 and 4,721,723.

It is believed that both the (−) and (+) forms of a compound of formula (III) are novel as are any mixtures thereof including the racemate. The present invention also extends to a compound of formula (III) or a salt or hydrate thereof, the (−) and (+) forms and any mixtures thereof including the racemate.

Compounds of formula (II) may be prepared according to the procedures outlined in U.S. Pat. No. 4,902,801.

The present invention is illustrated by the following example.

### EXAMPLE 1

### (−) trans-3-Ethoxycarbonyl-4-(4′fluorophenyl)-N-methyl piperidine-2,6-dione

A solution of (±) trans-3-Ethoxycarbonyl-4(4′-fluorophenyl)-N-methyl piperidine-2,6dione (1.51 g 5.15 mmol) in DMSO (100 ml) was added to Tris buffer (900 ml, 0.2 m, pH 5.5). The pH was readjusted to 5.5, pig liver esterase (Sigma Chemical Co, 19 ml, 5340 units) added and the reaction stirred for twenty hours. The pH was maintained by addition of aqueous sodium hydroxide (0.105 m, 25 ml, 2.63 mmol).

The reaction mixture was extracted with ether (3×300 ml), the combined organic extracts washed with Tris buffer (0.1M, pH 8.5, 2×250 ml), the Tris buffer extracts washed with ether (1×200 ml) and the combined organic extracts dried over anhydrous magnesium sulphate.

The reaction mixture was assayed at 16, 18 and 20 hours. On each occasion the enantiomeric ratio was 90:10 (−):(+).

The solution evaporated to an oil and replaced with toluene/THF. This solution was then reduced with lithium aluminium hydride. The final solution containing a 0.15 g of reduced material in 30 ml THF/toluene had a rotation of −16.5°. Chiral HPLC indicated an isomer ratio of 86:14 (−):(+).

1. A process for stereospecifically hydrolysing a mixture of the (+) and (−) isomers of a compound of formula (II): 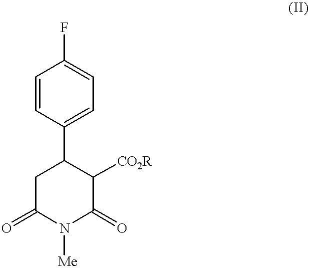
in which R is C₁₋₆alkyl; using a carboxyl esterase enzyme,
(i) to form a compound of formula (IIIA), 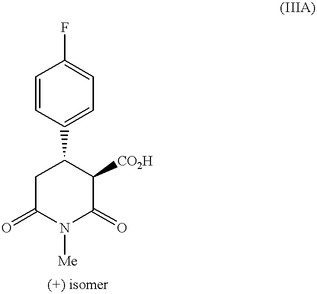
and thereafter separating the resulting compound of formula (IIIA) from the remaining (−) isomer of formula (II); or
ii) to form a compound of formula (IIIB): 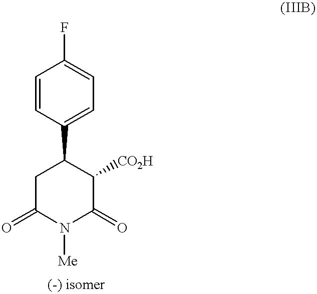
and thereafter separating the resulting compound of formula (IIIB) from the remaining (+) isomer of formula (II).

2. A process according to variant (i) in claim 1 in which the stereoselectivity of the process is such that from a racemic mixture of a compound of formula (II), after the action of the carboxyl esterase enzyme, the ratio of (−) to (+) isomer of formula (II), is greater than 60%.

3. A process according to variant (ii) in claim 1 in which the stereoselectivity of the process is such that from a racemic mixture of a compound of formula (II), after the action of the carboxy esterone enzyme, the ratio of (+) to (−) isomer of a compound of formula (II), is greater than 60%.

4. A process according to any one of claims 1 to 3 which is carried out by dissolving (±) unresolved compound of formula (II) into an aqueous/organic solvent mixture and adding the carboxyl esterase enzyme and stirring the resulting mixture until the reaction is completed.

5. A process according to any one of claims 1 to 4 in which the temperature for performing the reaction is 0-50° C.

6. A process according to any one of claim 1 to 5 in which the pH of the reaction is pH 4 to 8.

7. A process according to any one of claims 1 to 6 in which the variable R in formula (II) is methyl or ethyl.

8. A process according to claim 1 in which the carboxyl esterase enzyme is Porcine liver esterase or Bovine liver esterase.

9. A process for subsequently converting a (−) compound of formula (II), prepared as described in claim 1, to paroxetine or a pharmaceutically acceptable salt and/or solvate thereof.

10. A process for subsequently converting a (−) compound of formula (III), prepared as described in claim 1, to paroxetine by first converting it to a (−) compound of formula (II), as defined in claim 1, using conventional esterification techniques followed by subsequent convertion to paroxetine or a pharmaceutically acceptable salt and/or solvate thereof.

11. A process for subsequently converting a (−) compound of formula (III) directly to paroxetine by reducing the carboxylic acid group to a hydroxymethyl group and reducing the two keto groups in the piperidine ring and subsequently, converting the resulting piperidine carbinol to paroxetine or a pharmaceutically acceptable salt and/or solvate thereof.

12. A compound of formula (III) or a salt or hydrate thereof.
